(19) United States
(12) Patent Application Publication
(10) Pub. No.: US 2019/0128140 A1
(43) Pub. Date: May 2, 2019

(54) BEARING DEVICE FOR AN EXHAUST GAS TURBOCHARGER, AND EXHAUST GAS TURBOCHARGER

(71) Applicants: IHI CHARGING SYSTEMS INTERNATIONAL GMBH, Heidelberg (DE); IHI CHARGING SYSTEMS INTERNATIONAL GERMANY GMBH, Amt Wachsenburg Ot Ichtershausen (DE)

(72) Inventors: TORSTEN GRAMSCH, LANGEWIESEN (DE); MARTIN KRESCHEL, MANNHEIM (DE)

(73) Assignees: IHI CHARGING SYSTEMS INTERNATIONAL GMBH, HEIDELBERG (DE); IHI CHARGING SYSTEMS INTERNATIONAL GERMANY GMBH, AMT WACHSENBURG OT ICHTERSHAUSEN (DE)

(21) Appl. No.: 16/233,811

(22) Filed: Dec. 27, 2018

Related U.S. Application Data
(63) Continuation-in-part of application No. PCT/EP2017/000773, filed on Jun. 29, 2017.

(30) Foreign Application Priority Data
Jul. 7, 2016 (DE) 10 2016 112 520.2

(51) Int. Cl. F01D 25/16; F01D 25/20; F16C 19/14; F02B 39/08

(52) U.S. Cl. CPC F01D 25/162; F01D 25/20; F16C 19/14; F02B 39/08; F05D 2260/98; F05D 2220/40; F05D 2240/52; F05D 2260/406; F05D 2210/12

(57) ABSTRACT

A bearing device for an exhaust gas turbocharger, comprising a first radial bearing and a second radial bearing, the radial bearings radially support a shaft with an axis of rotation of the exhaust gas turbocharger, and wherein a first outflow gap and a second outflow gap, respectively, are formed between the first radial bearing and a radially extending first supporting wall of the turbocharger, which faces a turbine wheel of the exhaust gas turbocharger for axially supporting the first radial bearing, and the second radial bearing and a radially extending second supporting wall of the turbocharger, which faces a compressor wheel of the exhaust gas turbocharger for axially supporting the second radial bearing. The first outflow gap and/or the second outflow gap is configured inclined or curved relative to the axis of rotation for the axial and simultaneously radial support and/or for the backup of the radial support.

### CROSS-REFERENCE TO RELATED APPLICATIONS

This is a continuation-in-part application of pending international application PCT/EP2017/000773 filed Jun. 29, 2017, and claiming the priority of German application No. 10 2016 112 520.2 filed Jul. 7, 2016. The said International application PCT/EP2017/000773 and German application No. 10 2016 112 520.2 are both incorporated herein by reference in their entireties as though fully set forth.

The invention relates to a bearing device for an exhaust gas turbocharger of the type indicated in the preamble of Claim 1 as well as to an exhaust gas turbocharger according to Claim 11.

Unexamined publication DE 10 2008 033 814 A1 discloses a bearing device for an exhaust gas turbocharger whose radial bearings provided for the radial support of a shaft of the exhaust gas turbocharger are connected to a spacer which is arranged between the two radial bearings. The entire bearing device is integrally formed, i. e. the radial bearings and the spacer are manufactured together. Apart from an expensive manufacture of the bearing device, the problem of such a bearing device is also to be seen in the high material costs, because the bearing device is e. g. machined from a blank in an elaborate process.

Lubricant exits with a high flow velocity from a wall between the radial bearing and a wall opposite the radial bearing. This results in a high pressure on sealing rings which are provided for sealing against lubricant leakage into a compressor of the exhaust gas turbocharger and a turbine of the exhaust gas turbocharger.

It is the object of the present invention to provide an improved bearing device for an exhaust gas turbocharger. A further aspect of the invention is to provide a less costly exhaust gas turbocharger.

### SUMMARY OF THE INVENTION

This object is solved by a bearing device for an exhaust gas turbocharger with the features of Claim 1 as well as by an exhaust gas turbocharger according to Claim 11. Advantageous embodiments with suitable and non-trivial developments of the invention are indicated in the respective dependent claims.

The first aspect of the invention relates to a bearing device for an exhaust gas turbocharger with a first radial bearing and a second radial bearing, wherein the first radial bearing and the second radial bearing are configured for the radial support of a shaft of the exhaust gas turbocharger comprising an axis of rotation, and wherein a spacer is arranged between the two radial bearings. A first outflow gap and a second outflow gap, respectively, are formed between the first radial bearing and a radially extending first supporting wall of the exhaust gas turbocharger, which faces a turbine wheel of the exhaust gas turbocharger and serves as an axial support of the first radial bearing, and the second radial bearing and a radially extending second supporting wall of the exhaust gas turbocharger, which faces a compressor wheel of the exhaust gas turbocharger and is formed as an axial support of the second radial bearing. According to the invention, the first outflow gap and/or the second outflow gap is configured inclined or curved relative to the axis of rotation at least partially at an angle which is greater or smaller than 90° for the axial and simultaneously radial support and/or for the backup of the radial support.

Radial bearings according to the state of the art are formed cylindrically. This means in other words, that an outflow gap which is formed between the radial bearing and the supporting wall is disposed orthogonally to the axis of rotation. Therefore, lubricant from the outflow gap exits the outflow gap quasi vertically to the axis of rotation. Due to this outflow, a high pressure is imparted on sealing rings which are assigned to the bearing device and are intended to prevent the ingression of lubricant into a compressor of the exhaust gas turbocharger and a turbine of the exhaust gas turbocharger.

The advantage of the present invention is the creation of a specific outflow of lubricant from the outflow gap into a lubricant tank of the exhaust gas turbocharger, wherein the specific outflow is directed facing away from the sealing rings. Thereby, these are no longer subjected to the high load due to the high dynamic pressure of the impinging lubricant. The inclined or curved outflow gaps bring about a Venturi effect, whereby in particular lubricant is drawn-in at the radial bearing facing the exhaust gas guide section. Thus, the ingression of lubricant into the exhaust gas guide section is prevented.

In order to increase the oil pressure of the lubricant provided between the shaft and the radial bearing, the outflow gap is preferably designed inclined or curved in an outlet area of the outflow gap.

An embodiment of the first radial bearing and/or second radial bearing, e. g. shaped as a truncated cone whose major base is disposed facing the opposite radial bearing in each case, results in inclined wall surfaces of the radial bearings which, in turn, lead to an increase in the effective bearing surfaces of the radial bearings. The increase in the effective bearing surfaces results in enhanced damping of the rotary assembly during operation of the exhaust gas turbocharger. In addition, the stiffness of the bearing is also increased by the increase in the effective bearing surfaces. The term “effective bearing surface” refers to the sum of the bearing surfaces of the radial bearings, which are actually disposed opposite the shaft, and a proportion of the wall surface with a friction force component in the radial direction.

Another advantage is to be seen in a reduction of high precision bearing surfaces. The bearing surfaces simultaneously serve as radial and as axial bearing because of the inclined and/or curved configuration relative to the axis of rotation. This enables to reduce costs and consequently to realize a cost-efficient exhaust gas turbocharger. Slanted surfaces reduce the sensitivity of the oil gap in respect of length tolerances. The effect of the length tolerance is less pronounced due to the inclined and/or curved orientation. This results in a slower consumption of the lubricant gaps, which leads to a greater axial backlash and a more robust bearing device as a whole than in the state of the art.

In another embodiment, the first radial bearing and/or the second radial bearing is non-rotatably connected with the spacer.

Advantageously, the first radial bearing and/or the second radial bearing is integrally formed with the spacer.

In another embodiment, the first outflow gap and/or the second outflow gap comprises a first wall surface formed by the first radial bearing and a second wall surface respectively, formed by the second radial bearing, respectively, which is inclined relative to the axis of rotation. This allows influencing the configuration of the outflow gap already during the manufacture of the radial bearing. Even if a supporting wall which forms the outflow gap and is arranged opposite the wall surface extends orthogonally to the axis of rotation, the direction of the lubricant outflow may be influenced.

In another embodiment of the inventive bearing device, the first supporting wall of the shaft or the second supporting wall of the shaft opposite the first wall surface and/or the second wall surface of the shaft, respectively, is formed complementary to the first wall surface or the second wall surface, respectively. Thus, a defined outflow gap for influencing the lubricant pressure in the outflow gap may be realized in a well-defined manner.

In another embodiment of the inventive bearing device, the shaft comprises a shaft ring for forming the first supporting wall.

In another embodiment of the inventive bearing device, the second supporting wall is formed by an oil slinger ring of the exhaust gas turbocharger. The advantage is to be seen in that because the oil slinger ring a component which is manufactured separately from the shaft, the manufacture of a complementary or only partially complementary configuration of the supporting wall is possible without considerable additional expenditure. Furthermore, an additional centrifugal effect is achieved due to the inclined and/or curved outflow gap.

Another preferred embodiment is the manufacture of the spacer from a synthetic material, which results in weight reduction of the bearing device.

The second aspect of the invention relates to an exhaust gas turbocharger with a rotary assembly, wherein the rotary assembly comprises a compressor wheel, a turbine wheel and a shaft which connects the compressor wheel and the turbine wheel non-rotatably, wherein the rotary assembly is rotatably supported by a bearing device in a bearing portion. According to the invention, the bearing device is configured according to the claims.

The advantage of this invention is enhanced damping of the rotary assembly, so that the rotary assembly exhibits an improved running behavior because it may be operated more smoothly. In addition, the inventive bearing device increases the stiffness of the rotary assembly, which increases a resonance frequency of the rotor.

Furthermore, friction of the exhaust gas turbocharger is considerably reduced by means of the improved bearing device due to enhanced damping. This improved or reduced, respectively, friction of the inventive exhaust gas turbocharger results e. g. in a reduction of the fuel requirement of a combustion engine which is connected to the exhaust gas turbocharger, because the inventive exhaust gas turbocharger requires a smaller exhaust gas mass flow rate in order to achieve an output of the exhaust gas turbocharger compared to the state of the art.

### BRIEF DESCRIPTION OF THE DRAWINGS

Further advantages, features and details of the invention may be taken from the following description of preferred exemplary embodiments as well as from the drawings. The features and feature combinations as previously mentioned in the description as well as the features and feature combinations which will be mentioned in the following description of the figures and/or which are solely illustrated in the figures are not only applicable in the respective indicated combination but also in other combinations or isolated, without deviating from the scope of the invention. Identical or functionally identical elements are assigned identical reference numbers. In the drawings:

FIG. 1 shows a longitudinal section of an exhaust gas turbocharger according to the state of the art,

FIG. 2 shows a longitudinal section of an inventive bearing device in a first exemplary embodiment,

FIG. 3 shows a longitudinal section of the inventive bearing device in a second exemplary embodiment, and

FIG. 4 shows a perspective illustration of a first radial bearing, a second radial bearing and a spacer which is integrally formed with the first radial bearing and the second radial bearing of the inventive bearing device.

### DETAILED DESCRIPTION OF THE INVENTION

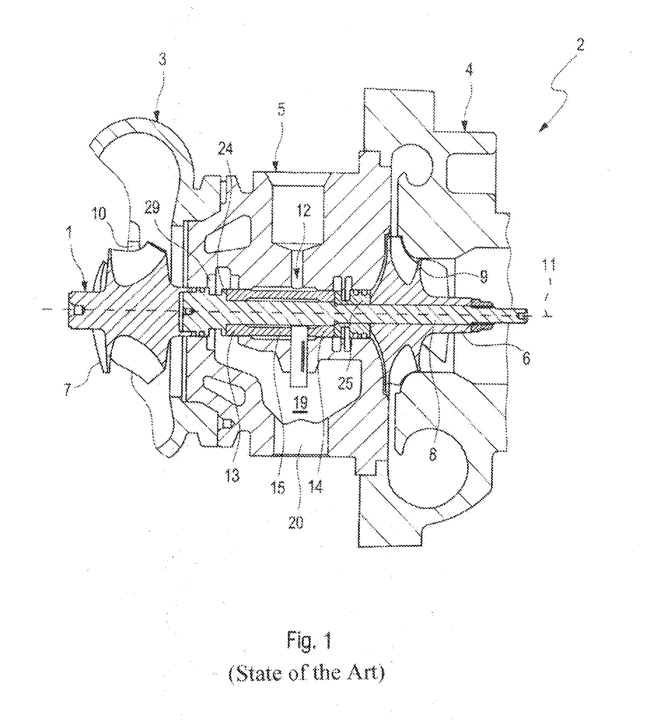

A rotary assembly 1 of an exhaust gas turbocharger 2 according to the state of the art is formed in a first exemplary embodiment according to FIG. 1. The exhaust gas turbocharger 2 comprises a flow-through exhaust gas guide portion 3 through which a fluid, generally exhaust gas, flows during operation of the exhaust gas turbocharger 2. Generally, but not necessarily, the exhaust gas is a combustion product of a combustion engine (not shown in detail).

The exhaust gas turbocharger 2 is assigned a flow-through air guide portion 4 as well as a bearing portion 5 which is positioned between the exhaust gas guide portion 3 and the air guide portion 4, wherein the rotary assembly 1 is rotatably accommodated in the bearing portion 5.

The rotary assembly 1 comprises a compressor wheel 6 and a turbine wheel 7, which are non-rotatably connected with each other by means of a shaft 8. The compressor wheel 6 is arranged in a compressor wheel chamber 9 of the air guide portion 4 for the intake of generally fresh air. The turbine wheel 7 is rotatably accommodated in a wheel chamber 10 of the exhaust gas guide portion 3.

During operation of the exhaust gas turbocharger 2, the turbine wheel 7 is subjected to and driven by the exhaust gas flowing through the exhaust gas guide portion, so that it performs a rotary motion about an axis of rotation 11 of the rotary assembly 1. This rotary motion may be transferred to the compressor wheel 6 by means of the shaft 8, which simultaneously to the rotary motion of the turbine wheel 7 performs a rotary motion. By means of the compressor wheel 6 and its rotary motion fresh air is sucked in which is compressed in the air guide portion 4.

The shaft 8 of the rotary assembly 1 is rotatably supported in the bearing portion 5 by means of a bearing device 12, comprising a first radial bearing 13 and a second radial bearing 14. An axial bearing (not shown in detail) for the axial support is additionally accommodated in the bearing portion 5 in the area of the compressor wheel 6. In the present exemplary embodiment, the first radial bearing 13 and the second radial bearing 14 exhibit the form of a semi-floating bearing.

The first radial bearing 13 and the second radial bearing 14 are arranged coaxially with the axis of rotation 11 of the rotary assembly 1, wherein a spacer 15 is provided between the first radial bearing 13 and the second radial bearing 14. The spacer 15 which is also referred to as spacer sleeve contributes to the axial location of the two radial bearings 13, 14 and is integrally and non-rotatably connected with the two radial bearings 13, 14.

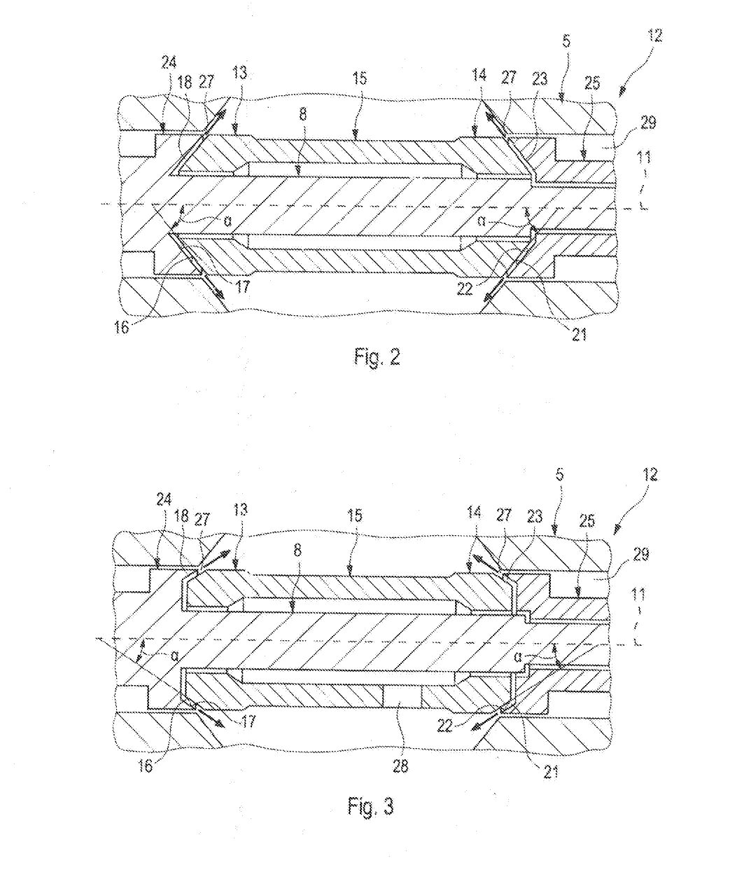

FIG. 2 shows a longitudinal section of an inventive bearing device 12. The first radial bearing 13 comprises a first wall surface 16 which faces the turbine wheel 7. A first outflow gap 18 is provided between the first radial bearing 13 and a first supporting wall 17 of the shaft 8, which is formed for the axial support of the first radial bearing 13. Lubricant which is provided for lubrication of the rotary assembly 1 support between the shaft 8 and the first radial bearing 13 may flow out into a lubricant tank 19 via this first outflow gap 18. The lubricant tank 19 is connected with a lubricant circuit (not shown in detail) of the combustion engine via an outlet channel 20.

The second radial bearing 14 comprises a second wall surface 21, wherein the second wall surface 21 faces the compressor wheel 6. A second outflow gap 23 is provided between the second wall surface 21 and a second supporting wall 22 of the of the shaft 8, which is formed for the axial support of the second radial bearing 14, via which the lubricant may flow out into the lubricant tank 19. The two outflow gaps 18, 23 are inclined relative to the axis of rotation 11 at an angle α each, which is smaller than 90°. Due to the inclined orientation of the outflow gaps 18, 23, which deviates from an orthogonal orientation relative to the axis of rotation 11, the lubricant is guided directly towards the outlet channel 20.

The outflow gaps 18, 23 may as well have a curved form. The outflow gaps 18, 23 could also be formed only partially inclined or curved. It is mandatory for the invention that the inclination or curvature are implemented in such a manner that the lubricant, contrary to an orthogonal outflow from the bearing device 12 as indicated in the state of the art, is diverted, in particular in an outlet area in of the outflow gaps 18, 23. This means in other words that the first outflow gap 18 and/or the second outflow gap 23 is formed inclined or curved relative to the axis of rotation 11 at least partially at an angle α which is greater or smaller than 90°, in particular in the outlet area 27 of the outflow gaps 18, 23. Thereby, the lubricant pressure in the bearing is increased, which increases the load bearing capacity of the bearing.

In the illustrated exemplary embodiment, the first wall surface 16 and the second wall surface 21 are formed complementary to the first supporting wall 17 and the second supporting wall 22, respectively.

The first supporting wall 17 is a wall of a shaft ring 24 which completely encompasses the shaft 8, and is formed integrally with the shaft 8. It could as well have been manufactured separately from the shaft 8 and non-rotatably joined with the shaft 8.

The second supporting wall 22 is constituted by an oil slinger ring 25 of the exhaust gas turbocharger 2.

In a second exemplary embodiment according to FIG. 3, the inventive bearing device 12 takes the form of a so-called semi-floating bearing. Here, the radial bearings 13, 14 which are integrally formed with the spacer 15 do not rotate. For locating purposes, a locating element (not shown in detail) is accommodated in a holder opening 28.

The outflow gaps 18, 23 comprise a diversion feature which generates a higher dynamic pressure compared to the first exemplary embodiment. This increases the load bearing capacity. The intake of lubricant from a chamber 29 formed between the oil slinger ring 25 and the bearing portion 5 is improved due to the enhanced Venturi effect, so that a passage of the lubricant into the exhaust gas guide portion 3 may be reduced or eliminated, respectively. In addition, the velocity of the lubricant at the outlet area 27 decreases, whereby the static pressure in the entire lubricant tank is reduced.

The diversion feature may also have a curved configuration.

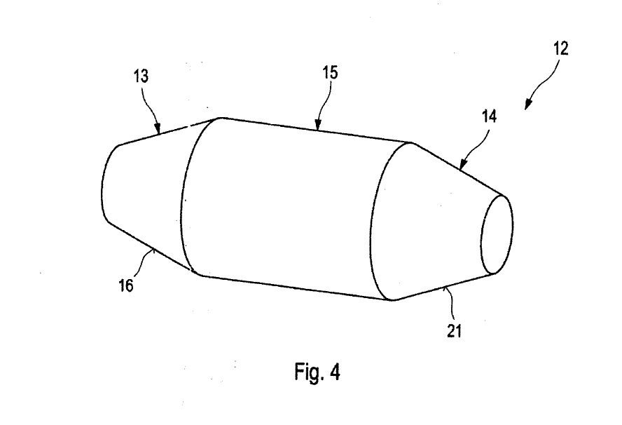

FIG. 4 shows in a perspective view the first radial bearing 13, the second radial bearing 14 and the spacer 15 which is integrally formed with the two radial bearings 13, 14. The radial bearings 13, 14 are formed as truncated cones, so that the bearing surface 26 of the radial bearings 13, 14 may be increased in a simple manner without additionally required installation space. The increase of the bearing surface 26 leads to a better or enhanced, respectively, damping of the rotary assembly 1 and to a stiffness of the support of the rotary assembly 1.

The angle α results in an increase of the effective bearing surface, wherein the bearing surface 26 is a part of this effective bearing surface. If the angle α takes the form of a flat angle, i. e. if its value is smaller than 45°, a considerable increase of the effective bearing surface is obtained.

What is claimed is:

1. A bearing device for an exhaust gas turbocharger, comprising a first radial bearing (13) and a second radial bearing (14), wherein the radial bearings (13, 14) are configured for the radial support of a shaft (8) of the exhaust gas turbocharger (2), and wherein a first outflow gap (18) and a second outflow gap (23), respectively, are formed between the first radial bearing (13) and a radially extending first supporting wall (17) of the exhaust gas turbocharger (2), which faces a turbine wheel (7) of the exhaust gas turbocharger (2) for axially supporting the first radial bearing (13), and between the second radial bearing (14) and a radially extending second supporting wall (22) of the exhaust gas turbocharger (2), which faces a compressor wheel (6) of the exhaust gas turbocharger (2) for axially supporting the second radial bearing (14), and wherein the shaft (8) comprises an axis of rotation (11),
characterized in that
the first outflow gap (18) and/or the second outflow gap (23) is configured inclined or curved relative to the axis of rotation (11) at least partially at an angle (α) which is greater or smaller than 90° for the axial and simultaneously radial support and/or for the backup of the radial support,
wherein an outlet area (27) of the outflow gap (18; 23) is arranged facing away from the wheels (6, 7) compared to an area of the outflow gap (18; 23) near the shaft (8).

2. The bearing device according to claim 1,
characterized in that
the first outflow gap (18) and/or the second outflow gap (23) is configured inclined or curved in the outlet area (27) of the outflow gap (18; 23) relative to the axis of rotation (11) at least partially at an angle (α) which is greater or smaller than 90°.

3. The bearing device according to claim 1,
characterized in that
a spacer (15) is provided between the first radial bearing (13) and the second radial bearing (14).

4. The bearing device according to claim 3,
characterized in that
the first radial bearing (13) and/or the second radial bearing (14) is non-rotatably connected with the spacer (15).

5. The bearing device according to claim 3,
characterized in that
the first radial bearing (13) and/or the second radial bearing (14) is integrally formed with the spacer (15).

6. The bearing device according to claim 1,
characterized in that
the first outflow gap (18) and/or the second outflow gap (23) comprises a first wall surface (16) formed by the first radial bearing (13) and a second wall surface (21), respectively, formed by the second radial bearing (14) respectively, which are configured inclined relative to the axis of rotation (11).

7. The bearing device according to claim 6,
characterized in that
a first supporting wall (17) of the shaft (8) or a second supporting wall (22) of the shaft (8) respectively, opposite the first wall surface (16) and/or the second wall surface (21), is formed complementary.

8. The bearing device according to claim 7,
characterized in that
the shaft (8) comprises a shaft ring (24) for forming the first supporting wall (17).

9. The bearing device according to claim 7,
characterized in that
the second supporting wall (22) is constituted by an oil slinger ring (25) of the exhaust gas turbocharger (2).

10. The bearing device according to claim 3,
characterized in that
the spacer (15) is formed from a synthetic material.

11. An exhaust gas turbocharger with a rotary assembly (1), wherein the rotary assembly (1) comprises a compressor wheel (6), a turbine wheel (7) and a shaft (8) which non-rotatably connects the compressor wheel (6) with the turbine wheel (7) wherein the rotary assembly (1) is rotatably supported in a bearing portion (5) by a bearing device (12),
characterized in that
the bearing device (12) comprises a first radial bearing (13) and a second radial bearing (14), wherein the radial bearings (13, 14) are configured for the radial support of a shaft (8) of the exhaust gas turbocharger (2), and
wherein a first outflow gap (18) and a second outflow gap (23), respectively, are formed between the first radial bearing (13) and a radially extending first supporting wall (17) of the exhaust gas turbocharger (2), which faces a turbine wheel (7) of the exhaust gas turbocharger (2) for axially supporting the first radial bearing (13), and between the second radial bearing (14) and a radially extending second supporting wall (22) of the exhaust gas turbocharger (2), which faces a compressor wheel (6) of the exhaust gas turbocharger (2) for axially supporting the second radial bearing (14), and wherein the shaft (8) comprises an axis of rotation (11),
characterized in that
the first outflow gap (18) and/or the second outflow gap (23) is configured inclined or curved relative to the axis of rotation (11) at least partially at an angle (α) which is greater or smaller than 90° for the axial and simultaneously radial support and/or for the backup of the radial support, wherein an outlet area (27) of the outflow gap (18; 23) is arranged facing away from the wheels (6, 7) compared to an area of the outflow gap (18; 23) near the shaft (8).

12. The exhaust gas turbocharger according to claim 11,
characterized in that
the first outflow gap (18) and/or the second outflow gap (23) is configured inclined or curved in the outlet area (27) of the outflow gap (18; 23) relative to the axis of rotation (11) at least partially at an angle (α) which is greater or smaller than 90°.

13. The exhaust gas turbocharger according to claim 11,
characterized in that
a spacer (15) is provided between the first radial bearing (13) and the second radial bearing (14).

14. The exhaust gas turbocharger according to claim 13,
characterized in that
the first radial bearing (13) and/or the second radial bearing (14) is non-rotatably connected with the spacer (15).

15. The exhaust gas turbocharger according to claim 13,
characterized in that
the first radial bearing (13) and/or the second radial bearing (14) is integrally formed with the spacer (15).

16. The exhaust gas turbocharger according to claim 11,
characterized in that
the first outflow gap (18) and/or the second outflow gap (23) comprises a first wall surface (16) formed by the first radial bearing (13) and a second wall surface (21), respectively, formed by the second radial bearing (14) respectively, which are configured inclined relative to the axis of rotation (11).

17. The exhaust gas turbocharger according to claim 16,
characterized in that
a first supporting wall (17) of the shaft (8) or a second supporting wall (22) of the shaft (8) respectively, opposite the first wall surface (16) and/or the second wall surface (21), is formed complementary.

18. The exhaust gas turbocharger according to claim 17,
characterized in that
the shaft (8) comprises a shaft ring (24) for forming the first supporting wall (17).

19. The exhaust gas turbocharger according to claim 17,
characterized in that
the second supporting wall (22) is constituted by an oil slinger ring (25) of the exhaust gas turbocharger (2).

20. The exhaust gas turbocharger according to claim 13,
characterized in that
the spacer (15) is formed from a synthetic material.
